(19) United States
(12) Patent Application Publication
(10) Pub. No.: US 2026/0276137 A1
(43) Pub. Date: Sep. 17, 2026

(54) Consumer-Grade Telescopic Matrix Based On Additive Manufacturing Technology

(71) Applicant: Shenzhen Matrix Quest Technology Co., Ltd., Shenzhen (CN)

(72) Inventor: Lihao Zhong, Guangzhou (CN)

(21) Appl. No.: 19/199,823

(22) Filed: May 6, 2025

(30) Foreign Application Priority Data
Mar. 11, 2025 (CN) 2025102824485

(51) Int. Cl. F16M 11/26; B33Y 80/00

(52) U.S. Cl. CPC F16M 11/26; B33Y 80/00

(57) ABSTRACT

The present invention discloses the consumer-grade telescopic matrix based on additive manufacturing technology, including: the base with at least one through-hole around which the surface of the base is fixedly connected with shaft sleeve. The top of the rotating rod passes through the shaft sleeve and is fixedly connected with the rotating head. The outer side of the rotating head is fixedly connected with the male thread. The outer side of the shaft sleeve is provided with the telescopic column. The telescopic column is provided with the female thread matched and connected to the male thread. The invention incorporates the hollow shaft sleeve and four guide rods within the base. The rotating rod is nested in the shaft sleeve requiring no fixing on the top, which greatly increases the structural strength, and no thread structure can be seen, which protects the thread and improves the overall aesthetics.

### TECHNICAL FIELD

This invention herein relates to the technical field of telescopic matrix, particularly relates to the consumer-grade telescopic matrix based on additive manufacturing technology.

### BACKGROUND OF THE PRESENT INVENTION

The existing telescopic matrix device generally refers to the telescopic matrix based on the mechanical structure system, and its components generally include telescopic column housings, lead screw, polish rod, holder; it has the disadvantages of large size, heavy weight, many metal parts, complex structure, limited minimum height, long assembly time, inability to automate production, baffles between single columns, and low assembly consistency precision; it is not suitable for potential consumer-grade product scenarios such as wall telescopic matrix three-dimensional decorative panels, retail store telescopic matrix display racks, and telescopic matrix board game chessboards; these products are featured by the characteristics of small size, light weight, environmentally friendly materials (such as all plastic), low product height, automated mass production, simple assembly, no baffles between columns, and high assembly precision requirements.

### SUMMARY OF PRESENT INVENTION

The main purpose of this invention is to provide the consumer-grade telescopic matrix based on additive manufacturing technology, aims to solve one of the technical problems recognized by the inventor.

This invention discloses the consumer-grade telescopic matrix based on additive manufacturing technology characterized in that it includes: base, the said base comprises at least one through-hole; the surface of the said base is fixedly connected with the shaft sleeve around the said through-hole; the rotating rod is embedded on the inner side of the said shaft sleeve; the top end of the said rotating rod passes through the shaft sleeve and is fixedly connected with the rotating head; the outer side of the said rotating head is fixedly connected with the male thread; the bottom end of the said rotating rod passes through the through-hole; the telescopic column is sleeved on the outer side of the said shaft sleeve; the said telescopic column is provided with the female thread; the said male thread and the said female thread are matched and connected.

Preferably, the surface of the said base is located around the said shaft sleeve and is fixedly connected with four guide rods; guide grooves are provided at positions corresponding to the guide rods of the said telescopic column; the said guide rods are embedded in the said guide grooves and can move axially along the guide grooves.

Preferably, the bottom end of the said rotating rod is fixedly connected with the driving head; the rotating head groove is provided on the inner side of the said driving head.

Preferably, the outer side of the said rotating rod is the polygonal thread structure.

Preferably, the outer diameters of the said rotating head and the said driving head gradually increase in the direction away from the said rotating rod.

Preferably, the outer side of the said male thread is cut.

Preferably, the interior of the said rotating rod is hollow.

Preferably, the said guide rod is integrally connected with the said shaft sleeve and the said base; the said guide groove is connected through the said female thread.

Preferably, the height of the said rotating head is less than 1 cm or within 25% of the effective telescopic length D; the said effective telescopic length is the sum of the heights of the said rotating rod and the said rotating head.

Preferably, the said base, the said shaft sleeve and the said rotating rod are all integrally formed by additive manufacturing technology.

The beneficial effects of the present invention herein are mainly as follows: the present invention herein provides the hollow sleeve and four guide rods on the base; the rotating rod is nested in the sleeve; no fixing parts are required on the top; and the structural strength is greatly increased; meanwhile, no thread structures can be seen during use; the thread is protected while the overall aesthetics is improved;

The present invention herein does not require baffles as stiffener structure between telescopic columns, thereby simplifying the structure and improving the aesthetics of the product;

And the whole is manufactured through 3D printing, and only the telescopic column needs to be assembled manually, which saves much manual assembly time, improves production efficiency, reduces labor intensity, and does not require any metal connectors, reduces processing difficulty, and increases overall quality.

It should be understood that the foregoing general description and the following specific embodiments are both for the purpose of example and explanation and do not necessarily limit the invention herein; and the accompanying drawings, which are incorporated into and form the individual part of the specification, illustrate the subject matter of the invention herein; at the same time, the instruction and the accompanying drawings are used to explain the principles of the invention herein.

### BRIEF DESCRIPTION OF THE DRAWINGS.

In order to more clearly illustrate the specific embodiments of the invention herein or the technical solutions in the prior art, the drawings required for use in the specific embodiments or the description of the prior art will be briefly introduced below; obviously, the drawings described below are some embodiments of the invention herein; for ordinary technicians in this field, other drawings can be obtained based on these drawings without paying any creative work.

FIG. 1 shows the schematic diagram of the three-dimensional structure of the single telescopic unit of the present invention;

FIG. 2 shows the schematic diagram of the assembly of the base and the rotating rod of the present invention;

FIG. 3 shows the schematic diagram of the structure of the rotating rod of the present invention;

FIG. 4 shows the schematic diagram of the structure of the telescopic column of the present invention;

FIG. 5 shows the schematic diagram of the structure of the base structure of the 8*8 array of the present invention;

Icon: 1—base; 2—shaft sleeve; 3—rotating rod; 4—rotating head; 41—male thread; 5—driving head; 51—rotating head groove; 6—guide rod; 7—telescopic column; 71—female thread; 72—guide groove.

### DETAILED DESCRIPTION

The technical solution of the present invention herein will be clearly and completely described below in conjunction with the accompanying drawings; obviously, the described embodiments are only part of the embodiments of the present invention herein, rather than all of the embodiments.

Based on the embodiments in the invention herein, all other embodiments obtained by ordinary technicians in the field without making any creative work shall fall within the scope of protection of the invention herein.

In the description of the present invention herein, it should be noted that the terms “center”, “upper”, “lower”, “left”, “right”, “vertical”, “horizontal”, “inner”, “outer”, etc., indicating the orientation or positional relationship, are based on the orientation or positional relationship shown in the drawings, and are only for the convenience of describing the present invention herein and simplifying the description, rather than indicating or implying that the device or element referred to must have the specific orientation, be constructed and operated in the specific orientation, therefore, cannot be understood as limiting the present invention herein, in addition, the terms “first”, “second”, and “third” are used for descriptive purposes only, and cannot be understood as indicating or implying relative importance.

In the description of the present invention herein, it should be noted that, unless otherwise clearly specified and limited, the terms “installed”, “connected”, and “connected” should be understood in the broad sense, for example, it can be the fixed connection, the detachable connection, or the integral connection; it can be the mechanical connection or the electrical connection; it can be the direct connection, or it can be indirectly connected through the intermediate medium, or it can be the internal communication of two components; for ordinary technicians in this field, the specific meanings of the above terms in the present invention herein can be understood according to specific circumstances.

### Embodiments

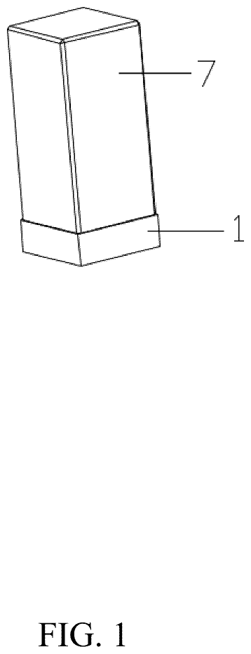

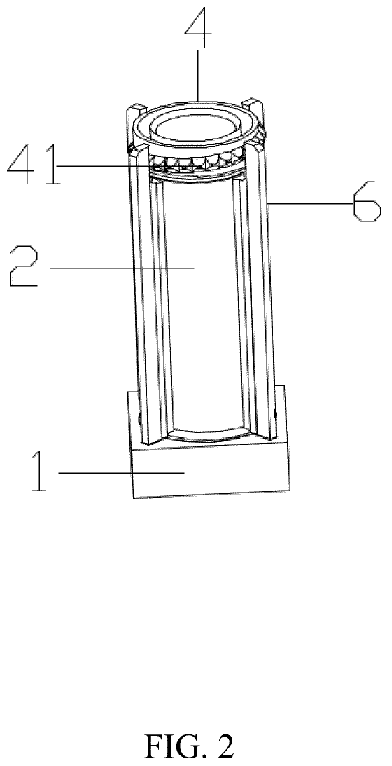

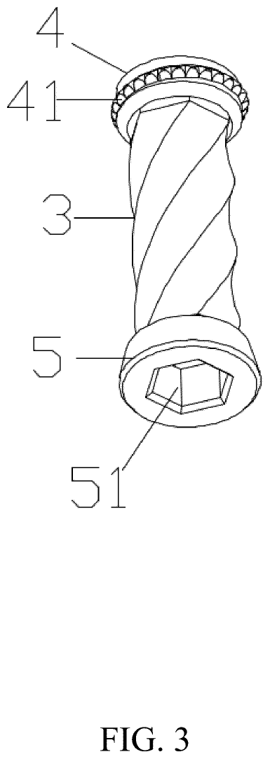

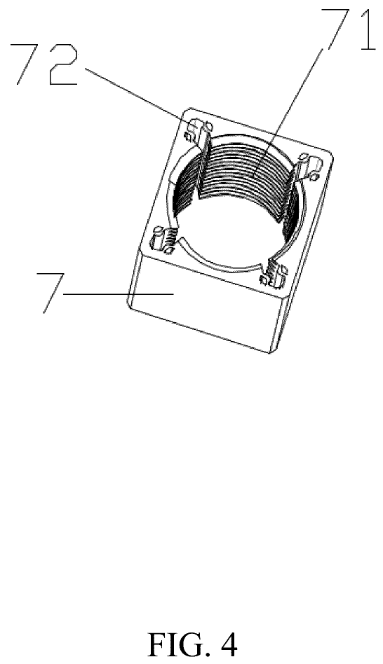

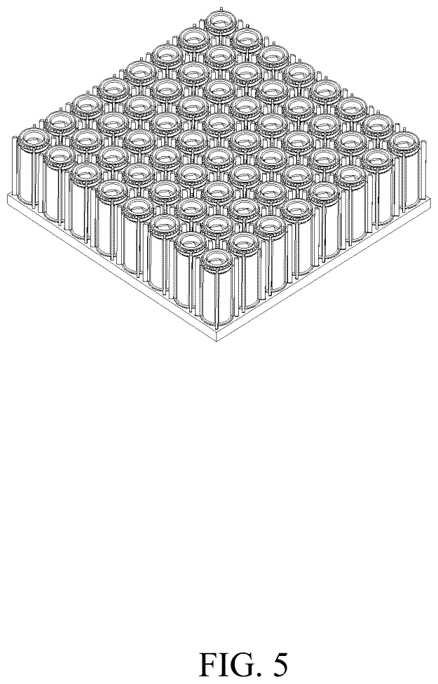

Referring to FIGS. 1 to 5, this embodiment provides the consumer-grade telescopic matrix based on additive manufacturing technology, comprising the said base 1, which is the main structure with the square cross-section; the base 1 has at least one through-hole distributed in the rectangular array on it; the number of through-holes can be set according to the number of telescopic units of the telescopic matrix; it can be customized according to the needs; each through-hole on the surface of the said base 1 is surrounded by the shaft sleeve 2, which is the closed circular ring structure without any gaps; the bottom and the through-hole are connected; rotating rod 3 is embedded inside the said shaft sleeve 2; the top of the said rotating rod 3 penetrates the said shaft sleeve 2 and is connected to rotating head 4 in the integrated manner; the outer side of the said rotating head 4 is integrally formed with the male thread 41; and the outer side of the said shaft sleeve 2 is fitted with the telescopic column 7 which is the rectangular cover structure; the interior of the telescopic column 7 is equipped with the female thread 71 that cooperates with the male thread 41; in this embodiment, the telescopic matrix is composed of multiple repeated units; each single unit base 1 is provided with one through-hole, corresponding to one shaft sleeve 2, one rotating rod 3, and one telescopic column 7; forming the matrix with multiple units only requires performing the array operation on the individual unit; the edges of base 1 will be automatically coupled together through 3D printing to form the integrated structure; while structures such as the shaft sleeve 2, rotating rod, and telescopic column 7, can also be combined into the telescopic matrix by array replication during 3D printing; it can be understood that the matrix is composed of multiple individual telescopic unit bases 1 coupled together to form the whole; in this embodiment, the cross-section of the base 1 of each single telescopic unit in the matrix is square; and the size can be within the range of 0.5-10 cm; users can customize according to their needs.

Furthermore, the surface of the said base 1 is integrally formed with four guide rods 6 around the said shaft sleeve 2; and the said telescopic column 7 is provided with the guide groove 72 at the position corresponding to the said guide rod 6; the said guide rod 6 is embedded in the said guide groove 72 and can move forward and backward along the direction of the guide groove 72; the guide groove 72 and the guide rod 6 are used for limiting and guiding, so that the telescopic column 7 can be restricted from rotating so that it can only move up and down, and can play the guiding role.

Furthermore, the integrally formed base, guide rod and shaft sleeve structure can greatly increase the structural strength of the base, thereby reducing the thickness of the base to less than 1 cm.

Among them, the bottom end of the said rotating rod 3 is integrally formed with the driving head 5 by 3D printing; the rotating head groove 51 is provided on the inner side of the said driving head 5; though inserting the screwdriver head or the motor rotor head into the rotating head groove 51, the driving head 5 is controlled to rotate, thereby driving the entire rotating rod 3 to rotate, thus realizing the control of the telescopic column 7; each rotating rod 3 is controlled separately, so that each telescopic column 7 can be controlled separately.

Furthermore, the outer side of the said rotating rod 3 is the polygonal thread structure, which is beneficial to reduce the friction between the rotating rod 3 and the shaft sleeve 2, prevent the rotating rod 3 from being worn, increase its service life, and make the rotating rod 3 rotate more smoothly; in this embodiment, the outer side of the said rotating rod 3 is the hexagonal thread structure; similarly, it can also be set to the 3-8 deformed thread structure, which is designed according to user needs.

In one embodiment, the outer diameters of the said rotating head 4 and the said driving head 5 gradually increase in the direction away from the said rotating rod 3; this structure is suitable for production using 3D printing technology; the rotating rod 3 and the base 1 are deposited and stacked upward along the Z-axis direction during production without interfering with each other; the driving head 5 tilts inward during the printing process to form the nested structure at the bottom; after the rotating rod 3 passes through the shaft sleeve 2, it extends outward at the 45-degree angle to form the rotating head 4, so that the rotating rod 3 is nested in the shaft sleeve 2 and cannot be pulled out, but retains the function of rotating inside; the overhang stacking technology unique to additive manufacturing technology is adopted here; when depositing outward at the angle, part of the material will be attached to the existing material, while the other part of the material will be suspended in the air, so as to realize the manufacturing of the outward-tilted structure at the certain angle.

Furthermore, the outer side of the said male thread 41 is cut to reduce the friction between the male thread 41 and the female thread 71 and to increase the service life.

Furthermore, the interior of the said rotating rod 3 is hollow. ; the hollow rotating rod 3 structure can effectively reduce the overall weight and solve the problem of heavy mass of the traditional telescopic matrix.

In one embodiment, the said guide rod 6 is integrally connected with the shaft sleeve 2 and the base 1; and the said guide groove 72 is connected through the said female thread 71; the bottom of the guide rod 6 is integrally formed with the base 1; the side surface is integrally formed with the outer wall of the shaft sleeve 2, which improves the overall structural strength of the base 1; the guide groove 72 is connected through the female thread 71, then the female thread 71 would be disconnected; this disconnected female thread 71 structure design is difficult to process or very expensive in traditional mold design methods, so it has the advantage of reducing its cost through additive manufacturing.

Furthermore, the height of the said rotating head 4 is less than 1 cm or within 25% of the effective telescopic length d; the said effective telescopic length is the sum of the heights of the rotating rod 3 and the rotating head 4; the overall height of the product can be effectively reduced, and the occupied size can be reduced.

Furthermore, the said base 1, the said shaft sleeve 2, and the said rotating rod 3 are all integrally formed by additive manufacturing technology; the additive manufacturing technology may be 3D printing.

Working principle of the present invention herein: base 1, shaft sleeve 2 and rotating rod 3 of the present invention herein are all made of 3D printing technology, which omits the steps of manual assembly and greatly improves the production efficiency; when in use, the screwdriver head or the motor rotor head is inserted into the rotating head groove 51; and the rotating head groove 51 is rotated to drive the rotating rod 3 and the rotating head 4 to rotate synchronously; the rotating head 4 rotates; the telescopic column 7 is limited by the guide rod 6 so that it cannot rotate and can only move forward and backward along the Z-axis direction, thereby realizing the stretch of the telescopic column 7; the user can customize the telescopic matrix according to needs; each telescopic unit is copied through arraying and then printed out through 3D printing; the outer wall of the base 1 is automatically coupled and adhered, and no additional modeling operation is required, which greatly saves labor costs.

Finally, it should be noted that the above embodiments are only used to illustrate the technical solutions of the present invention herein, rather than to limit them; although the present invention herein has been described in detail with reference to the aforementioned embodiments, those skilled in the field should understand that they can still modify the technical solutions described in the aforementioned embodiments, or replace some or all of the technical features therein by equivalents; however, these modifications or replacements do not cause the essence of the corresponding technical solutions to deviate from the scope of the technical solutions of the embodiments of the present disclosure.

1. The consumer-grade telescopic matrix based on additive manufacturing technology, characterized in that it includes: base, the said base comprises at least one through-hole; the surface of the said base is fixedly connected with the shaft sleeve around the said through-hole; the rotating rod is embedded on the inner side of the said shaft sleeve; the top end of the said rotating rod passes through the shaft sleeve and is fixedly connected with the rotating head; the outer side of the said rotating head is fixedly connected with the male thread; the bottom end of the said rotating rod passes through the through-hole; the telescopic column is sleeved on the outer side of the said shaft sleeve; the said telescopic column is provided with the female thread; the said male thread and the said female thread are matched and connected.

2. The consumer-grade telescopic matrix based on additive manufacturing technology according to claim 1, characterized in that the surface of the said base is located around the said shaft sleeve and is fixedly connected with four guide rods; guide grooves are provided at positions corresponding to the guide rods of the said telescopic column; the said guide rods are embedded in the said guide grooves and can move axially along the guide grooves.

3. The consumer-grade telescopic matrix based on additive manufacturing technology according to claim 1, characterized in that the bottom end of the said rotating rod is fixedly connected with the driving head; the rotating head groove is provided on the inner side of the said driving head.

4. The consumer-grade telescopic matrix based on additive manufacturing technology according to claim 3, characterized in that the outer side of the said rotating rod is the polygonal thread structure.

5. The consumer-grade telescopic matrix based on additive manufacturing technology according to claim 3, characterized in that the outer diameters of the said rotating head and the said driving head gradually increase in the direction away from the said rotating rod.

6. The consumer-grade telescopic matrix based on additive manufacturing technology according to claim 3, characterized in that the outer side of the said male thread is cut.

7. The consumer-grade telescopic matrix based on additive manufacturing technology according to claim 3, characterized in that the interior of the said rotating rod is hollow.

8. The consumer-grade telescopic matrix based on additive manufacturing technology according to claim 2, characterized in that the said guide rod is integrally connected with the said shaft sleeve and the said base; the said guide groove is connected through the said female thread.

9. The consumer-grade telescopic matrix based on additive manufacturing technology according to claim 1, characterized in that the height of the said rotating head is less than 1 cm or within 25% of the effective telescopic length d; the said effective telescopic length is the sum of the heights of the said rotating rod and the said rotating head.

10. The consumer-grade telescopic matrix based on additive manufacturing technology according to claim 1, characterized in that the said base, the said shaft sleeve and the said rotating rod are all integrally formed by additive manufacturing technology.
